(19) United States
(12) Patent Application Publication
(10) Pub. No.: US 2009/0175622 A1
(43) Pub. Date: Jul. 9, 2009

(54) METHOD FOR ALLOCATING UPSTREAM TRANSMISSION BANDWIDTH IN WDM-EPON

(75) Inventors: Hye Kyung Lee, Seoul (KR); Min Young Chung, Seoul (KR); Tae-Jin Lee, Gyeonggi-do (KR); Hyun Seung Choo, Gyeonggi-do (KR)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Sungkyunkwan University Foundation for Corporate Collaboration, Gyeonggi-do (KR)

(21) Appl. No.: 12/034,548

(22) Filed: Feb. 20, 2008

(30) Foreign Application Priority Data
Jan. 9, 2008 (KR) 10-2008-0002607

(51) Int. Cl. H04J 14/02

(52) U.S. Cl. 398/79

(57) ABSTRACT

Disclosed is a method fox allocating upstream transmission bandwidth so as to prevent Inter-Scheduling Cycle Gaps (ISCGs) from occurring in an N number of Optical Network Units (ONUs) by using an m number of wavelength channels for upstream transmission in a Wavelength-Division Multiplexing (WDM)-Ethernet Passive Optical Network (EPON). The method includes: grouping the ONUs to be allocated each of the m number of wavelength channels; and performing a Dynamic Bandwidth Allocation (DBA) algorithm in order for the grouped ONUs to efficiently use allocated wavelengths and time slots, thereby allocating each wavelength channel. Accordingly, by using a scheme of managing ONUs by each group, it is possible to more efficiently allocate bandwidth than the online scheduling scheme. As compared with the offline scheduling scheme, ISCGs caused by bandwidth allocation do not occur.

### CROSS-REFERENCE TO RELATED APPLICATIONS

The present patent application claims priority from Korean Patent Application No. 10-2008-0002607, filed on Jan. 9, 2008.

### BACKGROUND OF THE INVENTION

1. Field of the Invention

The present invention relates to a method for allocating upstream transmission bandwidth in a Wavelength-Division Multiplexing (WDM)-Ethernet Passive Optical Network (EPON), and more particularly to a method for allocating upstream transmission bandwidth in a WDM-EPON, in which multiple Optical Network Units (ONUs) are grouped according to a number greater by ‘1’ than the number of wavelength channels used for upstream transmission, a Dynamic Bandwidth Allocation (DBA) algorithm is carried out or; the grouped ONUs, and then the grouped ONUs are allocated channels.

2. Description of the Prior Art

Passive Optical Network (PONS technology for realizing Fiber-To-The-Curb/Home/Office (FTTx) can solve a traffic bottleneck situation occurring in a subscriber network due to an increase of internet users and a rapid increase of various services, including voice, data, multimedia, and other types of transmission.

A PON corresponds to a scheme in which a passive optical splitter requiring no power source and arranged between a service provider and an ONU branches a cable connected to each ONU off several cables. In this scheme, there is no need for power supply facilities for active elements and facility management required in an Active Optical Network (AON), and the number of times necessary to bury optical cables can be reduced. Therefore, this scheme can reduce costs required to construct a network.

The PON technology is classified into Wavelength Division Multiplexed-PON (WDM-PON), Asynchronous Transfer Mode-PON (ATM-PON), and EPON, according to used data-link layer technology.

The WDM-PON refers to the technology of transmitting an optical signal having multiple wavelengths through a piece of optical fiber, in which, since each subscriber uses an independent wavelength, it is possible to provide dedicated line-level bandwidth and high-level security. Nevertheless, the WDM-PON has technological difficulties existing in management and control for wavelength allocation by each subscriber.

The ATM-PON has the advantage that it is easy to support Quality of Service (QoS) through an ATM traffic control and management function, but has such disadvantages as a lack of video transmission capability, insufficient bandwidth, high complexity, and a high cost required to construct a network.

On the other hand, the EPON as an Ethernet protocol-based phone network provides maximum upstream/downstream transmission bandwidth of 1 Gbps through low-priced Ethernet devices, and accordingly, has merits as compared with other PON technologies in aspects of compatibility and price.

In the EPON, one Optical Line Terminal (OLT) is connected to an N number of ONUs via a 1:N passive optical splitter, which forms a tree-structure topology of point-to-multipoint. Due to the 1:N point-to-multipoint structure between the OLT and the N ONUs, a downstream signal starting from the OLT is transmitted in a broadcasting scheme.

As the downstream signal passes through the passive optical splitter, the strength of the downstream signal is reduced by 1/N, and is then delivered to all ONUs. Each ONU selects data having the ONU as the destination thereof among downstream signals, converts the selected data into an electric signal, and then delivers the electric signal to each subscriber. The ONUs collect signals from subscribers, convert the collected signals into optical signals, and then deliver the converted signals to the OLT. While the ONUs are controlled by the OLT, each ONU can transmit data to the OLT within only a time slot allocated by the OLT.

FIG. 1 illustrates a structure of a conventional EPON system. The EPON system has an asymmetric transmission structure, in which one OLT is connected to an N number of ONUs in the case of a downstream signal, and one OLT is connected to one ONU in the case of an upstream signal. Therefore, since a frame transmitted by an ONU on an upstream channel cannot be sensed by other ONUs, it is impossible to prevent a collision between signals by means of a Carrier Sense Multiple Access with Collision Detection (CSMA/CD) protocol scheme used in the existing Ethernet. So as to avoid the collision, IEEE recommends, as a standard, a Multi-Point Control Protocol (MPCP) established by adding the control function of an Ethernet frame to an IEEE 802.3 Media Access Control (MAC) protocol. The MPCP protocol provides a plan of sharing an upstream channel according to a Time Division Multiple Access (TDMA) scheme.

The MPCP defines both a REPORT control message used in order for the ONU to request a time slot and a GATE control message used in order for the OLT to allocate a time slot to an ONU. The REPORT message includes information on a current buffer state of the ONU itself necessary for the ONU to be allocated a time slot by the OLT. The GATE message prescribes a transmission start time and the length or a time slot of each ONU. Even though an ONU requires no time slot for having no data to be transmitted, the OLT allocates a minimum time slot necessary for the REPORT message to the GNU. Then, the REPORT message is included in the last part of an upstream signal, and is then delivered to the OLT. Based on the MPCP, a single OLT can control multiple ONUs by using the control messages as described above, and upstream traffic transmission can be efficiently performed according to the TDMA scheme in a point-to-multipoint structure.

The EPON system has merits as compared with other PON technologies in terms of compatibility and price. However, since multiple ONUs share one optical cable, the EPON system has difficulties in overcoming a limit on transmission capacity and a limit on the number of subscribers, according to an increase of bandwidth required to provide a broadband video and multimedia service requiring the guarantee of QoS. So as to settle the above problems, a WDM-EPON system having a structure upgraded, through a WDM overlay, from an EPON which has already been installed has been proposed. In the WDM-EPON, multiple wavelengths are used differently from the transmission of upstream frames in the TDMA scheme by using a single wavelength, and accordingly, it is possible to provide each subscriber with high-efficient transmission bandwidth.

By expanding the MPCP used by a conventional EPON system, the WDM-EPON system can use the expanded MPCP as a control protocol. While a GATE message used in the EPON prescribes only a transmission start time and the length of a time slot regarding each ONU, information on transmission/reception wavelengths is additionally defined in a GATE message for supporting the WDM-EPON.

In the WDM-EPON system, so as to efficiently control transmissions among ONUs, online and offline scheduling techniques are utilized. In the online scheduling technique, after the OLT receives REPORT messages from ONUs, the OLT allocates, to a relevant ONU, a time slot and a wavelength capable of transmitting data so that each ONU can continue to transmit data at guard time intervals therebetween. The OLT allocates a time slot and a wavelength to a relevant ONU through scheduling whenever the single ONU requires bandwidth. On this account, the OLT does not consider the amount of requirements of all ONUs, and accordingly, has difficulty in efficient time slot allocation.

FIG. 2 illustrates an example of the process of transmitting data in a conventional offline scheduling scheme when an N number of ONUs use one wavelength for downstream and two wavelengths for upstream. In the offline scheduling technique, the OLT receives REPORT messages of all ONUs, computes bandwidth usable by each ONU according to a DBA algorithm (S1), and then provides information on a time slot period and a wavelength available to each ONU by using a GATE message (S2).

In the offline scheduling technique, consideration regarding the amount of requirements of all enables a fair bandwidth allocation among the ONUs. However, until a last ONU completes the transmission of an upstream signal, and a first ONU begins to transmit an upstream signal at the next transmission period, an Inter-Scheduling Cycle Gap (ISCG), i.e. a channel idle period, exists (S3), so that uplink resources are used inefficiently.

FIG. 3 illustrates an example of a data transmission process for removing disadvantages caused by an Inter-Scheduling Cycle Gap (ISCG) occurring in a conventional offline scheduling when an N number of ONUs use one wavelength for downstream and two wavelengths for upstream. To an ONU requiring a time slot below a predetermined threshold (S1), a time slot equivalent to the amount of requirements is immediately allocated without a special computation process (S2), and then relevant ONUs can transmit data for ISCGs (S3). Even though ISCGs can be reduced by a bandwidth allocation method as illustrated in FIG. 3, ISCGs still exist (S3), which causes an inefficient use of uplink sources.

### SUMMARY OF THE INVENTION

Accordingly, the present invention has been made to solve the above-stated problems occurring in the prior art, and it is an object of the present invention to provide a method for allocating upstream transmission bandwidth in a WDM-EPON in such a manner as to efficiently use limited resources on wavelengths and time slots used for upstream traffic transmission in a WDM-EPON system, in which ONUs are grouped, and then bandwidth is allocated so as to transmit data by each of the ONU groups at start time points of synchronized period and sub-periods, thereby minimizing ISCGs and improving the total throughput.

It is another object of the present invention to provide a method for allocating upstream transmission bandwidth in a WDM-EPON, which defines a Dynamic Bandwidth Allocation (DBA) method capable of transmitting upstream frames by efficiently using wavelength channels and time slots in a WDM-EPON system, and so as to transmit upstream frames by efficiently using wavelength channels and time slots in the WDM-EPON system, determines a method for dividing each wavelength channel according to an equal period and then synchronizing divided each wavelength channel, a method for determining the number of groups according to the number of wavelengths used for upstream transmission, and the number of ONUs included in one group.

In accordance with an aspect of the present invention for achieving the above objects, there is provided a method for allocating upstream transmission bandwidth so as to prevent ISCGs from occurring in an N number of ONUs by using an m number of wavelength channels for upstream transmission in a WDM-EPON, the method including the steps of; grouping the ONUs to be allocated each of the m number of wavelength channels; and performing a DBA algorithm in order fox the grouped ONUs to efficiently use allocated wavelengths and time slots, thereby allocating each wavelength channel.

Preferably, the m number of wavelength channels are synchronized with one another with respect to one period is set with a maximum allowable period (Tₘₐₓ) corresponding to a system parameter of a conventional EPON system using a single wavelength as a point of reference, and the m number of wavelength channels are synchronized with one another with respect to an m number of sub-periods into which the one period is divided.

More preferably, all ONUs are classified into an m+1 number of groups, and the number of ONUs allocated to each communication channel is defined as

$$⌈ \frac{N}{m + 1} ⌉ ,$$

where ┌x┐ is defined as a minimum integer equal to or greater than x. If the total number (N) of ONUs is not a multiple of the number (m+1) of groups, ONUs belonging to each group are sequentially replaced, thereby uniformly maintaining the number of ONUs included in one group.

### BRIEF DESCRIPTION OF THE DRAWINGS

The above and other exemplary features, aspects, and advantages of the present invention will be more apparent from the following detailed description taken in conjunction with the accompanying drawings, in which:

FIG. 1 illustrates a structure of a conventional EPON system;

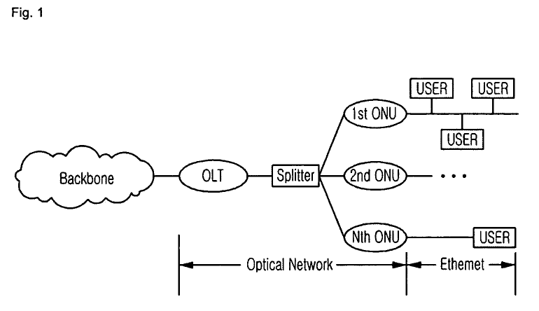

FIG. 2 illustrates an example of the process of transmitting data in a conventional offline scheduling scheme when an N number of ONUs use one wavelength for downstream and two wavelengths for upstream;

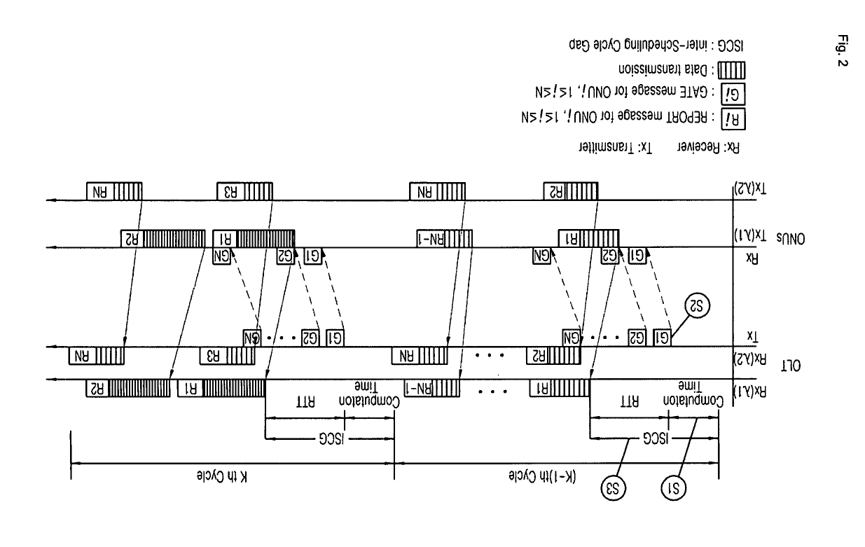

FIG. 3 illustrates an example of a data transmission process for removing disadvantages caused by an Inter-Scheduling Cycle Gap (ISCG) occurring in a conventional offline scheduling when an N number of ONUs use one wavelength for downstream and two wavelengths for upstream;

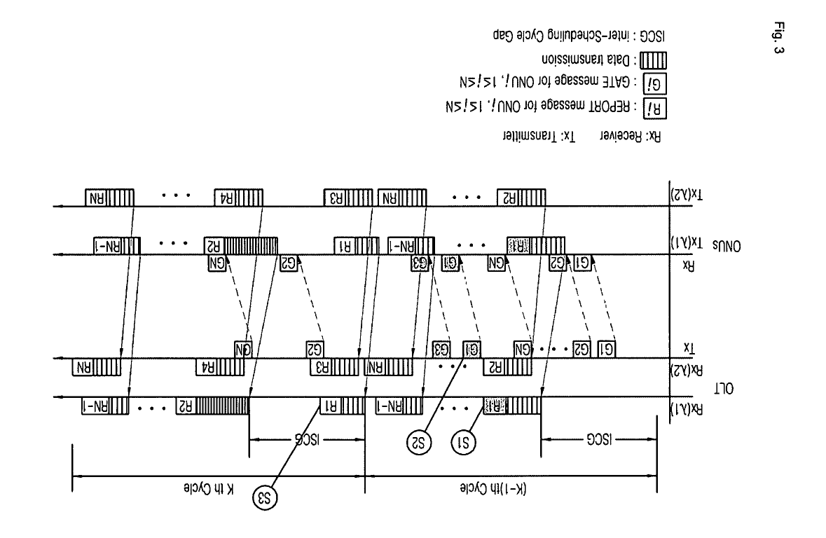

FIG. 4 is a flowchart showing a data transmission process for upstream transmission using a method proposed in the present invention;

FIG. 5 illustrates an example of a data transmission process when the number (N) of ONUs equals ‘9’ and the number (m) of wavelengths used for upstream transmission equals ‘2’; and

FIG. 6 illustrates an example of a data transmission process in the case of the occurrence of the remainder when the number ‘N’ of ONUs is divided by the number ‘m+1’ of groups.

### DETAILED DESCRIPTION OF THE EXEMPLARY EMBODIMENTS

Hereinafter, exemplary embodiments of the present invention will be described in detail with reference to the accompanying drawings. In the following description of the present invention, a detailed description of known functions and configurations incorporated herein will be omitted when it may make the subject matter of the present invention rather unclear.

In embodiments of the present invention, a method for dividing each wavelength channel according to an equal period and then synchronizing divided each wavelength channel should he considered. If a relevant period is set to an excessively large value, it leads to the increase of packet delay. On the contrary, if the relevant period is set to an excessively small value, it results in an increase of bandwidth wasted by guard time.

Hence, when a single wavelength is used in a conventional EPON system, all used wavelength channels are synchronized with one another with a maximum allowable period Tₘₐₓ corresponding to a system parameter as the reference. In the case of a system using multiple wavelengths for upstream transmission, a period can be applied in accordance with an environment of the system depending on the number of wavelengths and the number of ONUs. The number of sub-periods is related to the number of wavelengths, and when the number of wavelengths used for upstream transmission equals ‘m’, the number of sub-periods equals ‘m.’

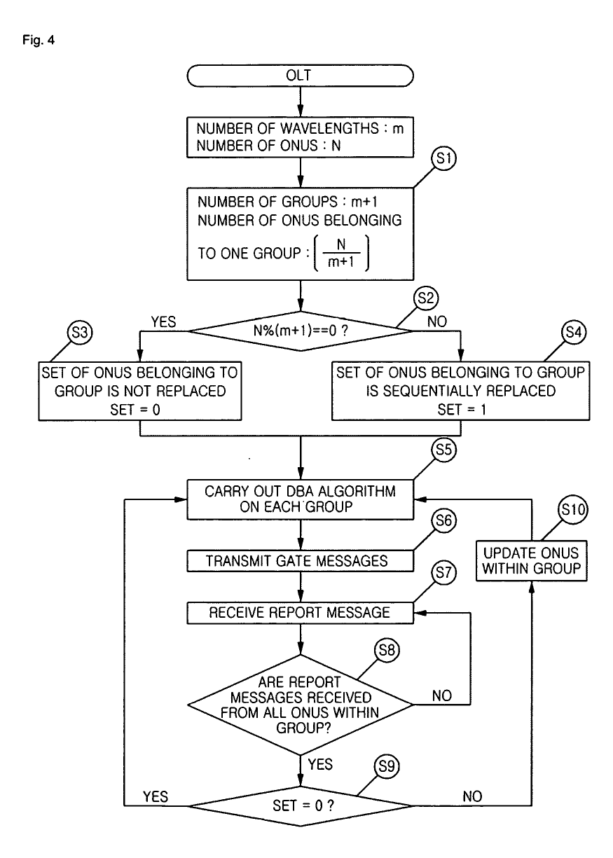

FIG. 4 is a flowchart showing a data transmission process for upstream transmission using a method proposed in the present invention. In a WDM-EPON system, by using the number ‘m’ of wavelengths for up-stream transmission and the number ‘N’ of configured ONUs, the number of groups and the number (i.e.

$$⌈ \frac{N}{m + 1} ⌉ \text{)}$$

of ONUs belonging to each group are determined (S1), where ┌x┐ is defined as a minimum integer equal to or greater than x.

If the remainder equals ‘0’ when the number ‘N’ of ONUs is divided by the number ‘m+1’ of groups, the ONUs belonging to each group are not replaced (S2 and S3).

If the remainder does not equal ‘0’ when the number ‘N’ of ONUs is divided by the number ‘m+1’ of groups, the ONUs belonging to each group are sequentially replaced, thereby uniformly maintaining the number of ONUs included in one group (S2 and S4).

An OLT performs a DBA algorithm for allocating a wavelength and a time slot by each group (S5).

If a set of wavelengths (λ) used by an number of ONUs so as to transmit upstream frames corresponds to {1, 2, 3, . . . , m} and a set of groups used by an ‘N’ number of ONUs so as to transmit upstream frames corresponds to {1, 2, 3, . . . , m, m+1), a group 1 uses λ₁, a group 2 uses λ₂, . . . , a group m uses λₘ, and the last group, a group m+1, uses λ₁. After all of an ‘m+1’ number of groups complete transmissions of their data, a wavelength to be used by each group in the next transmission period is specified in such a manner that the group 1 is assigned λ₂, the group 2 is assigned λ₃, and so on. Namely, covering overall periods, the groups sequentially correspond to the wavelengths used for upstream transmission.

The OLT synchronizes multiple wavelength channels with one another, divides multiple synchronized wavelength channels according to an equal period and an equal sub-period, and then allocates bandwidth to the grouped ONUs in such a manner as to prevent ISCGs from occurring. Even when a system is initially driven, or ONUS don't need to be allocated time slots due to having no data to be transmitted, a minimum time slot for a REPORT message is allocated.

The OLT transmits GATE messages, in regular sequence, to ONUs belonging to each group (S6). Each GATE message transmitted in step S6 includes information on transmission start times and time slots computed by the DBA algorithm, and information on wavelengths to be used in the next transmissions of data.

Upon receiving a GATE message, an ONU transmits frames for an allocated time slot at the transmission start time defined within the received GATE message by using an allocated wavelength, computes information remaining in a queue, and then transmits a REPORT message to the OLT (S7).

The OLT determines if it has received REPORT messages from all ONUs belonging to one group (S8). If the OLT has received REPORT messages from all ONUs belonging to one group, it determines if it updates a set of ONUs included in the relevant group (S9). If it is necessary to update the set of ONUs included in the relevant group, the OLT performs the update (S10), and then carries out the DBA algorithm, on each group (S4).

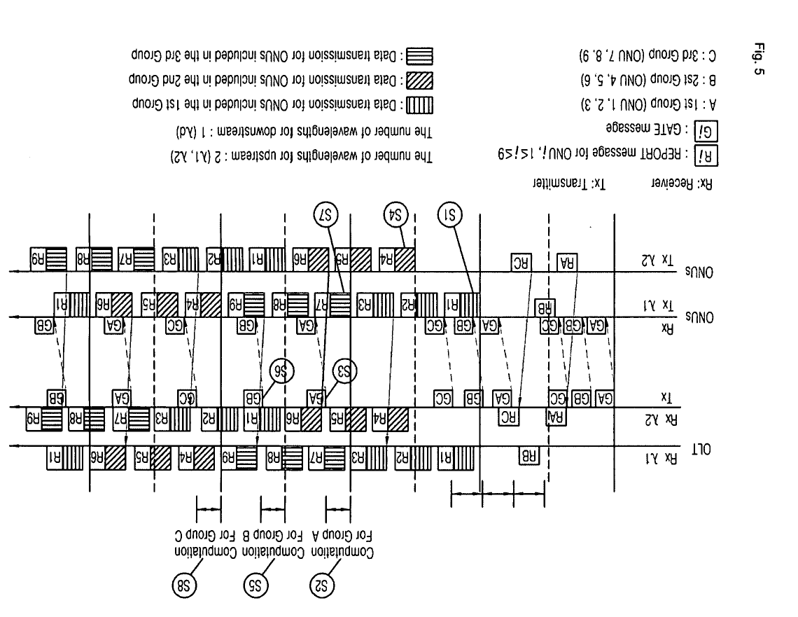

FIG. 5 illustrates an example of a data transmission process when the number (N) of ONUs equals ‘9’ and the number (m) of wavelengths used for upstream transmission equals ‘2.’ If one synchronized period is expressed as Tₘₐₓ, the number of sub-periods constructing the Tₘₐₓ equals the number ‘m’ of wavelengths. The number ‘m+1’ of groups equals ‘3’, and the number of ONUs belonging to each group equals

$$⌈ \frac{N}{m + 1} ⌉ ,$$

so that three ONUs belong to one group. When the number ‘N’ of ONUs is divided by the number ‘m+1’ of groups, the remainder equals ‘0’, and accordingly, ONUs belonging to each group are not replaced. Upon receiving GATE messages, each of the ONUs belonging to the group 1 transmits frames by using λ₁ during the length of a time slot at a transmission start time by the ONU, included in the received GATE message (S1). The transmission start time of the first ONU of the group 1 is equal to a start time point of a period synchronized among wavelength channels. The OLT which has received data and a REPORT message from the last ONU of the group 1 computes a time slot for the next transmissions of ONUs belonging to the group 1 (S2), and then transmits GATE messages (S3). A transmission, start, time of the first ONU ONU4 belonging to the group 2 corresponds to a start time point of a sub-period, later by Tₘₐₓ/m than a time point the group 1 begins to transmit data, and the first ONU ONU4 transmits frames by using λ₂, (S4). If the transmissions of the group 2 are completed, the OLT computes a time slot for the next transmissions of ONUs belonging to the group 2 (S5), and then transmits GATE messages (S6). The group 3 transmits frames by using the wavelength λ₃ at a start time point of the next synchronized period (S7). If the transmissions of ONUs within the group 3 are completed, the OLT performs the DBA algorithm based on received REPORT messages (S8).

When the number of ONUs is not a multiple of the number of groups, the DBA algorithm carried out on each group changes the number of ONUs belonging to one group, and thus, the fairness of bandwidth allocation decreases. So as to solve this problem, in the present invention, a method in which ONUs belonging to each group are sequentially replaced, thereby uniformly maintaining the number of ONUs included in one group, is used.

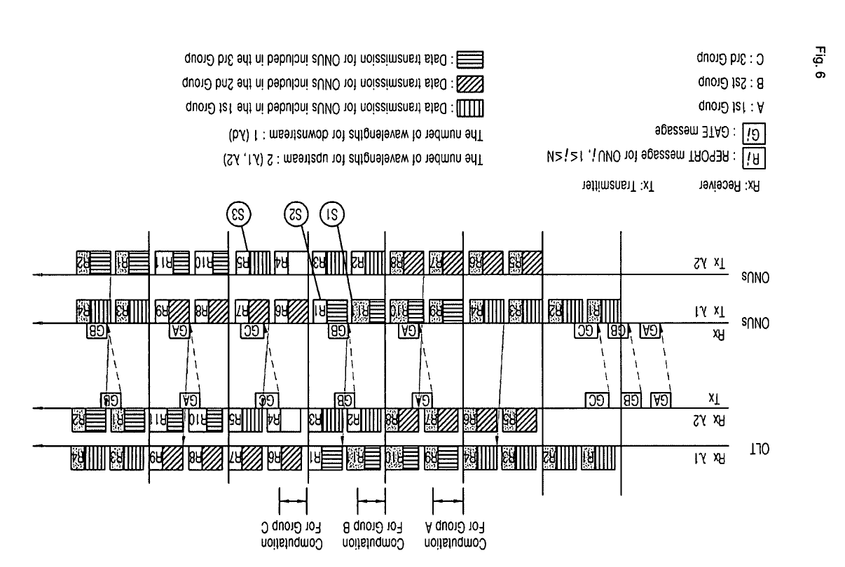

A description will be made by citing a case where the number of ONUs is not a multiple of the number of groups. FIG. 6 illustrates an example of a data transmission process in the case of the occurrence of the remainder when the number ‘N’ of ONUs is divided by the number ‘m+1’ of groups. In a case illustrated in FIG. 6, the number ‘m’ of wavelengths used for upstream transmission equals ‘2’ and the number ‘N’ of ONUs equals ‘11’. Accordingly, the number of ONUs belonging to each group, computed by an equation

$$⌈ \frac{N}{m + 1} ⌉ ,$$

equals ‘4’. The group 1 is allocated the first, second, third, and fourth ONUs. The group 2 is allocated the fifth, sixth, seventh, and eighth ONUs. The group 3 is allocated the ninth, tenth, and eleventh ONUs. Then, transmissions of frames proceed. In group 3, if the transmission of the eleventh ONU is finished (S1), the first ONU has the last transmission opportunity of the relevant group (S2). In the next transmission, the second ONU having its order next to the first ONU, the third, fourth, and fifth ONUs form one group named group 1 (S3). In the same manner as above, the ONUs belonging to each group are sequentially replaced. On this account, the problem that a change of the number of ONUs lowers the fairness of bandwidth allocation can be settled.

The merits and effects of a method for allocating upstream transmission bandwidth in a WDM-EPON according to the present invention will be described below.

First, in the case of complying with a conventional online scheduling scheme, the amount of requirements of all ONUs is not considered, and thus, it is hard to efficiently allocate bandwidth. In an offline scheduling scheme for solving the problems raised in the conventional online scheduling scheme, even though bandwidth is allocated in consideration of the amount of requirements of all ONUs, computation time necessary to consider the amount of requirements of all ONUs causes the occurrence of ISCGs. In the present invention, by using a scheme of managing ONUs by each group, it is possible to more efficiently allocate bandwidth than the online scheduling scheme. As compared with the offline scheduling scheme, ISCGs caused by bandwidth allocation do not occur.

Second, even though the number of wavelengths used by ONUs or the number of ONUs for upstream transmission changes, various and flexible WDM-EPON systems can be constructed, based on the relation among wavelengths and groups, and the number of ONUs within each group, used for defined upstream transmission.

Third, when the number of ONUs is not relative to the number of groups, the number of groups belonging to one group changes, and accordingly, the fairness of bandwidth allocation decreases. In the present invention, ONUs belonging to each group are sequentially replaced, and then the number of ONUs belonging to one group is uniformly maintained, thereby enabling a fair bandwidth allocation.

As a result, it is possible to raise channel usage and overcome a limit on transmission capacity in a WDM-EPON system requiring an efficient use of limited resources.

While the invention has been shown and described with reference to exemplary embodiments thereof, it will be understood by those skilled in the art that various changes in form and details may be made therein without departing from the spirit and scope of the invention. Therefore, the spirit and scope of the present invention must be defined not by described embodiments thereof but by the appended claims and equivalents of the appended claims.

What is claimed:

1. A method for allocating upstream transmission bandwidth so as to prevent Inter-Scheduling Cycle Gaps (ISCGs) from occurring in an N number of Optical Network Units (ONUs) by using an m number of wavelength channels for upstream transmission in a Wavelength-Division Multiplexing (WDM)-Ethernet Passive Optical Network (EPON), the method comprising;
grouping the ONUs to be allocated each of the m number of wavelength channels; and
performing a Dynamic Bandwidth Allocation (DBA) algorithm in order for the grouped ONUs to efficiently use allocated wavelengths and time slots, thereby allocating each wavelength channel.

2. The method as claimed in claim 1, wherein the m number of wavelength channels are synchronized with one another with respect to one period.

3. The method as claimed in claim 2, wherein the one period is set with a maximum allowable period (Tₘₐₓ) corresponding to a system parameter of a conventional EPON system using a single wavelength as a point of reference.

4. The method as claimed in claim 2, wherein the m number of wavelength channels are synchronized with one another with respect to an m number of sub-periods into which the one period is divided.

5. The method as claimed in claim 1, wherein, in the step of grouping the ONUs, all ONUs are classified into an m+1 number of groups.

6. The method as claimed in claim 1, wherein, in the step of grouping the ONUs, the number of ONUs allocated to one group is defined as
$$⌈ \frac{N}{m + 1} ⌉ ,$$
where ┌x┐ is defined as a minimum integer equal to or greater than x.

7. The method as claimed in claim 6, wherein, if the total number (N) of ONUs is not a multiple of the number (m+1) of groups, ONUs belonging to each group are sequentially replaced, thereby uniformly maintaining the number of ONUs included in one group.

8. The method as claimed in claim 5, wherein the m number of wavelength channels are synchronized with one another with respect to one period, and the m number of wavelength channels are synchronized with one another with respect to an m number of sub-periods into which the one period is divided, thereby initiating, by the grouped ONUs, transmissions of upstream, frames at each start time point of the period and the sub-periods synchronized among wavelength channels used for upstream transmission.

9. The method as claimed in claim 8, wherein one period is set with a maximum allowable period (Tₘₐₓ) corresponding to a system parameter of a conventional EPON system using a single wavelength as a point of reference.
